(19) United States
(12) Patent Application Publication
(10) Pub. No.: US 2013/0167343 A1
(43) Pub. Date: Jul. 4, 2013

(54) AIR CONDITIONING COMPRESSOR LINE AND VEHICLE FUEL LINE DISCONNECTOR TOOL

(71) Applicant: Lisle Corporation, Clarinda, IA (US)

(72) Inventors: William M. Goulet, Blackstone, MA (US); Lucy Goulet, Blackstone, MA (US)

(73) Assignee: Lisle Corporation, Clarinda, IA (US)

(21) Appl. No.: 13/728,759

(22) Filed: Dec. 27, 2012

Related U.S. Application Data
(60) Provisional application No. 61/581,255, filed on Dec. 29, 2011.

(51) Int. Cl. B25B 27/02

(52) U.S. Cl. CPC B25B 27/02
USPC 29/237

(57) ABSTRACT

A tool for decoupling fluid lines includes first and second substantially identical handles pivotably joined and including jaws with spaced prongs in a plane parallel to a connecting pivot pin of the handles. The prongs of each handle may be differentially spaced to facilitate engagement with a coupler and coupler release device.

### CROSS REFERENCE TO RELATED APPLICATION

This is a utility application incorporating by reference and claiming priority to provisional application Ser. No. 61/581,255 filed Dec. 29, 2011 entitled “Gas and Air Conditioner Disconnector”.

### BACKGROUND OF THE INVENTION

In a principal aspect the present invention relates to a tool for engaging and disconnecting air conditioning compressor lines and vehicle fuel lines.

When repairing various types of equipment and machinery, it is often necessary to disconnect couplers of fluid flow lines such as air conditioning compressor lines and vehicle fuel lines. Typically, such lines include connectors or couplers which may snap or be joined together to provide a leak-proof, sealed passage between the separate lines. In order to disconnect the lines, various types of tools have been proposed. For example, the products depicted in the following listed patents, incorporated by reference, disclose tools which may be positioned on vehicle line couplers and manually manipulated to effect disconnection of the lines.

Patents

| U.S. PAT. NO. | ISSUE DATE | TITLE |
|---|---|---|
| 5,455,995 | Oct. 10, 1995 | Tool for Uncoupling Quick |
| | | Connect Tubular Couplings |
| 7,127,787 | Oct. 31, 2006 | Tool for Disconnecting a Fuel |
| | | Line From a Fitting |
| 7,350,282 | Apr. 1, 2008 | Tool for Disconnection of |
| | | Tubing from a Coupling |
| 7,404,245 | Jul. 29, 2008 | Fuel Line Disconnect Tool |

While such tools have been found to be useful, they may suffer drawbacks. For example, when insertion on the connector or coupler, they may bind or become distorted or damaged thereby affecting their utility. Additionally, the coupler may be corroded or may have accumulated debris. Thus, there has developed a need for additional types of tools which can be used to effectively disconnect such couplers. It is especially desirable to have tools which will provide extra mechanical advantage.

Therefore, it is an object of the invention to provide an improved air conditioner compressor line and vehicle fuel line coupler disconnection tool. Such a tool should be rugged, generally inexpensive, and have utility for use with a wide range of connectors or couplers.

Another aspect and further benefit sought in such tools is the capability to be useful with respect to “heavy duty” connectors or couplers.

Another aspect and object of such a tool is to provide a tool which will not be easily damaged or distorted as a result of use.

These and other objects, advantages and features are sought with respect such a tool.

### SUMMARY OF THE INVENTION

Briefly, the present invention comprises a pliers type tool wherein first and second substantially identical unitary pliers type members, which include a handle section, an intermediate pivot connection section and a jaw section, are pivotally joined together by a connection pin or rivet to provide a tool especially designed to engage and disconnect couplers and other connectors. The separate unitary elements or members comprising the pliers type tool may be varied somewhat, but because of their design, provide manufacturing benefits as well as benefits with respect to their use. For example, the component parts are substantially identical except for variations in certain limited features such as the alignment of the component parts and the size of the component parts. Further, the design characteristics of the tool enable manufacture of the tool from a stamped form blank, metal workpiece with a minimal amount of additional working required to make a tool that is useful with multiple types of and sizes of couplers. The tool thus may include and be comprised of a pair of flat, generally uniform thickness plates which each incorporate a jaw section with spaced prongs. The jaw section of each plate is formed or bent transversely to the main handle and body of the plate. Each jaw section includes a slot between the prongs with a centerline axis aligned with one side of the pivot or intermediate section of the tool and is also generally aligned with a medial centerline axis of the handle section. The distance between the jaws of each prong is typically varied.

Thus, it is an object of the invention to provide a tool for decoupling line couplers.

Another object of the invention is to provide a tool for disconnecting a variety of coupler or connector sizes and configurations.

Yet another object of the invention is to provide a tool which is inexpensive, rugged and safe to use for decoupling line couplers.

These and other objects and aspects of the invention are set forth in the detailed description which follows.

### BRIEF DESCRIPTION OF THE DRAWING

In the detailed description which follows, reference will be made to the drawing comprised of the following figures:

FIG. 1 is a plan view of a first unitary element which incorporates a handle, an intermediate or pivot section and a jaw section. Two such elements or parts form the tool;

FIG. 2 is a top plan view of the element shown in FIG. 1;

FIG. 3 is a plan view of the assembled component parts of the tool;

FIG. 4 is an exploded isometric view of the component parts of the tool; and

FIG. 5 is an isometric view of the tool illustrating its use.

### DESCRIPTION OF AN EMBODIMENT

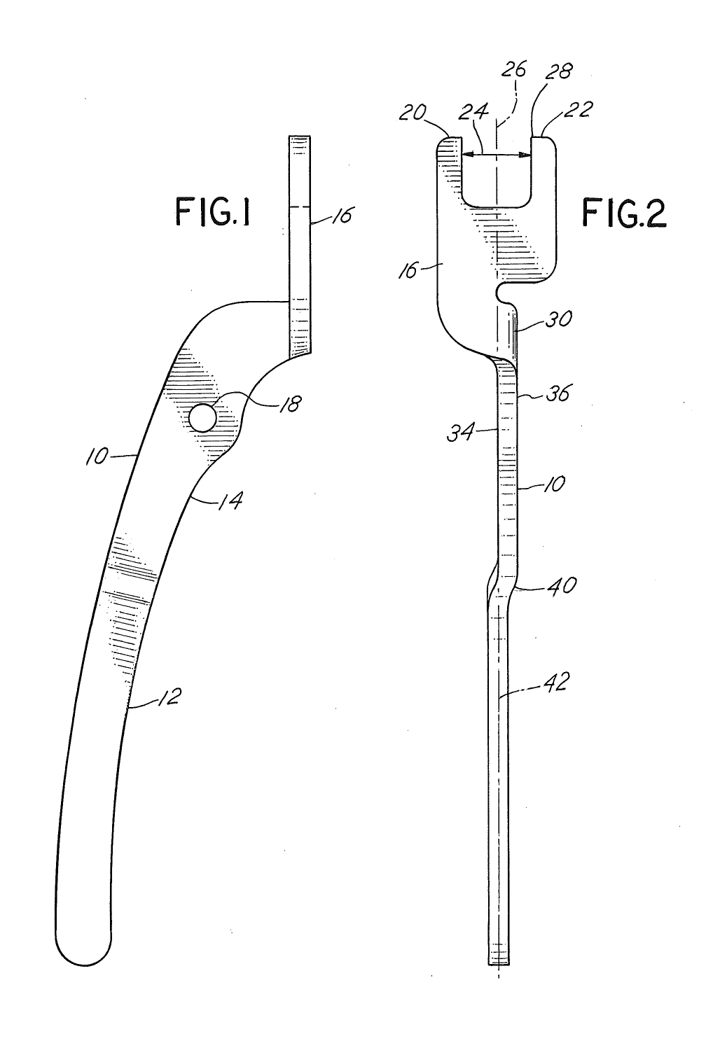

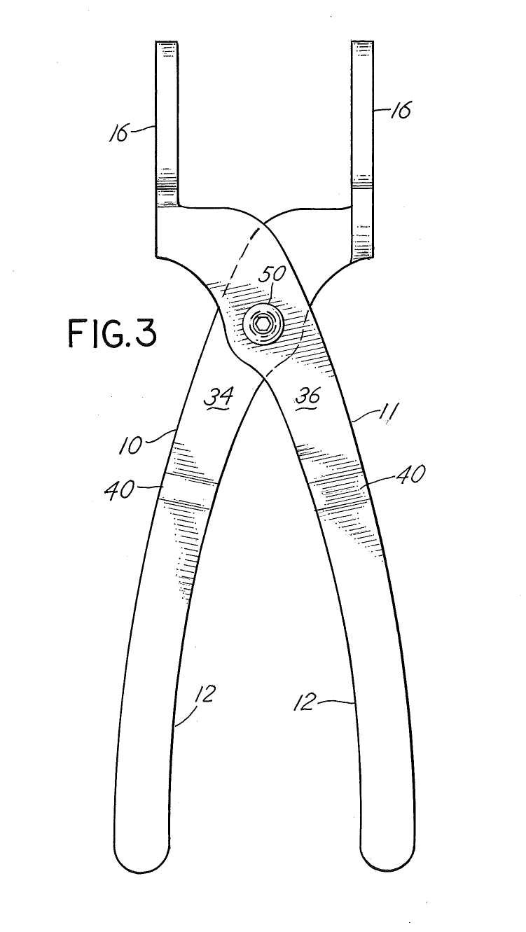

Referring to the figures and, in particular, FIGS. 1 and 2, there is depicted a first unitary member or element or part for assembly of the tool of the invention. The member or element 10 is comprised of a handle section 12 joined to an intermediate pivot section 14 which, in turn, is joined by a connecting section 15 to a jaw section 16. The sections 12, 14, 15, 16, joined together, thus form a unitary member, part or element. The part may be fabricated from a single uniform thickness metal plate or sheet such as a steel sheet and may be formed by a stamping process and a subsequent bending step. More specifically, the arcuate handle 12 may be stamped from a flat metal sheet simultaneously with the intermediate section 14, connecting section 15 and jaw section 16. The intermediate section 14 is laterally offset relative to handle section 12 and includes a pivot opening 18. The jaw section 16 may then be positioned by bending the connecting section 15 to position the jaw section 16 transversely to intermediate section 14.

The jaw section 16 includes first and second spaced prongs 20, 22 which are separated by a width W or 24. The inner edges of the prongs 20, 22 are equally spaced from a centerline axis 26. The prongs 20, 22 are formed with an outer or distal outer end 28. The prongs 20, 22 are of equal size and equal length although the length and/or width of one or more of the prongs 20, 22 of the tool may be varied.

The prongs 20, 22 are initially formed, as is the jaw section 16, in the stamping process. Subsequently, the jaw section 16 is positioned by effecting a bend 30 of the connecting neck section 15 transversely at a right angle to align the jaw section 16 transversely to the flat planar side 34 of intermediate section 14. The longitudinal centerline axis 26 of the tool is generally coincident with a centerline between prongs 20, 22. Axis 26 also coincides with a first side 34 of the intermediate section 14.

In the embodiment depicted, the first flat planar side 34 of the intermediate section 14 is spaced uniformly from the parallel second side 36 of the intermediate section 14. A slight double bend 40 is also formed between the intermediate section 14 and the handle section 12. The handle section 12 includes a longitudinal medial axis 42 coincident with the longitudinal centerline axis 26 of the tool. This alignment is depicted in FIG. 2. The medial axis 42 is coincident with the flat planar side 34 of the medial section and jaw section 16.

In order to construct a complete tool, two substantially similar parts, elements or members 10 of the type shown in FIGS. 1 and 2 are joined together by a pivot pin 50 as depicted in FIG. 3. Pivot pin or rivet 50 fits through the pivot openings 18 and joins opposed first sides 34 of elements or members 10 in abutting relationship. The bend 30 of the neck section 15 of each member or element 10 may be effected in an opposite direction in which event the second sides 36 of two intermediate sections 14 of two members 10 are arranged in an abutting relationship.

In any event, one part, component, member or element 10 serves as a left hand handle as indicated in FIG. 3 and a second part, component, member or element 11 serves as a right hand handle. The handle sections 12 of each of the two members or elements 10, 11 include elastomeric or plastic grips 51. The separate jaw sections 16 pivot toward each other about the rivet or pin 50 in response to movement or closure of the handles 10, 11. The pin 50 thus defines an axis of rotation generally parallel to the plane defined by the jaw sections 16 and laterally spaced prongs 20, 22 of each member 10, 11.

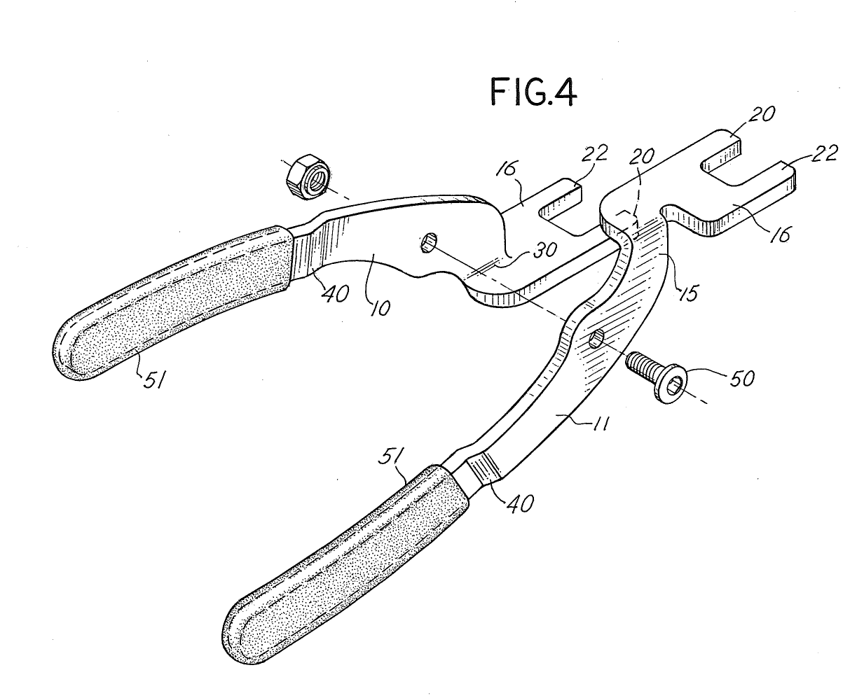

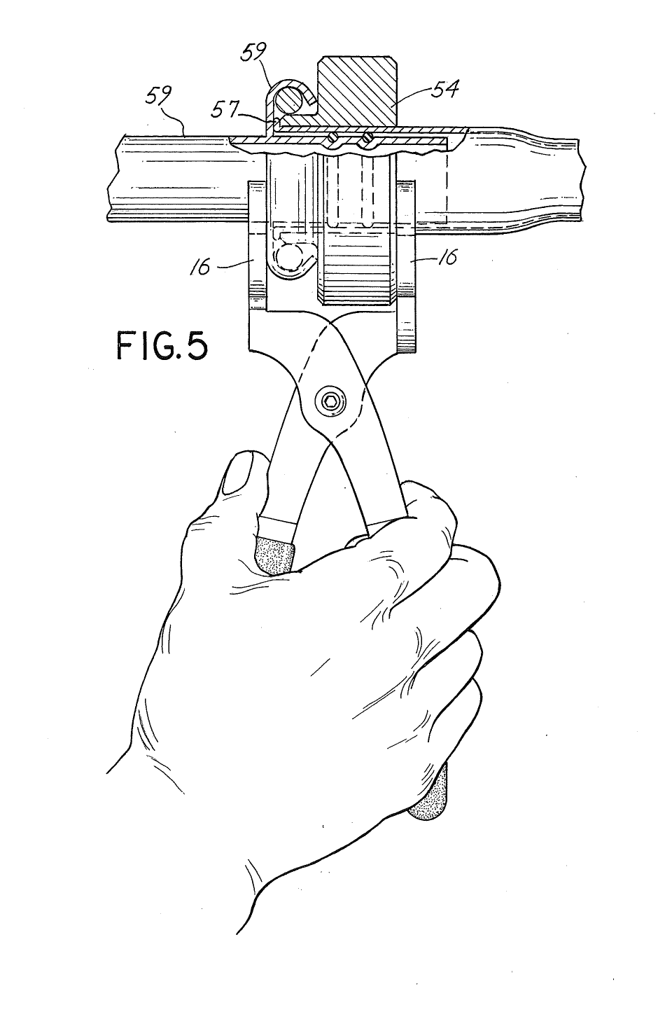

FIG. 4 is an isometric view of the component parts forming the tool. The dimensional characteristics of the tool are generally important inasmuch as they must cooperate with various types of connectors or couplers used in automotive and similar situations. Additionally, the width W or 24 between the inside edge of the prongs 20, 22 is typically varied. That is, one of the sets of prongs 20, 22 will have a greater width 24 than the width 24 of the second set of prongs 20, 22 in a finished tool as shown in FIG. 3. This is to accommodate various types of couplers. The distinction in the width 24 is often an important feature of the invention. This feature also insures that the tool can be used in combination with a decoupler device as depicted in U.S. Pat. No. 7,127,787 or U.S. Pat. No. 7,350,282 or as depicted in FIG. 5 of U.S. Pat. No. 5,455,995.

FIG. 5 depicts the manner of use of the tool. That is, the prongs 20, 22 associated with the respective jaw sections 16 are fitted on opposite sides of the coupler. More specifically, a coupler release tool or member 54 is inserted into the annular release space 57 around a tubular line 59 into the coupler housing 55 as taught, for example, in U.S. Pat. No. 7,127,787 or U.S. Pat. No. 7,350,282 or U.S. Pat. No. 5,455,995 (incorporated herein by reference). One set of opposed prongs 20, 22 is then fitted around the line 59 and the other prongs 20, 22 are fitted against the release member or tool 55. The handles 10, 11 are then manipulated to force the release tool 54 into engagement with the coupler release elements in the coupler housing 55. The jaw sections 16 are sized and, in particular, the distance 24 between each set of the prongs 20, 22 is sized to make sure that the coupler elements and the tool 53 are appropriately engaged, squeezed or compressed, thus enabling the release of the coupler and disconnection of a line 59.

Since the component parts are stamped from a flat, planar metal sheet of uniform thickness, the inside edges of the prongs 20, 22 are, in effect, right angle engaging surfaces. As such, they will tightly grip and hold coupler components when the handles or handle sections 12 are squeezed together and prongs 20, 22 clamp down on a coupler housing 55. Also, the face of the prongs 20, 22 which fit against the outer face of the disconnect or decoupler tool 53 are flat to insure appropriate evenly placed pressure on the tool 53 transverse to the internal decoupling elements in the interior in the coupler housing 55. In other words, the design of the prongs 20, 22 facilitates their appropriate engagement with a coupler.

The symmetrical characteristics of the tool along with the sizing and positioning of the prongs 20, 22 and the alignment of the medial axis 42 with the midpoint axis 26 of the jaw section 16 and, in particular, the midpoint axis 26 between the prongs 20, 22 ensures that the disconnection of couplers is effected by uniform application of force on the coupler locking elements. This prevents potential damage that may arise. Symmetry of the tool along the axis 26 and coincident with the abutting sides 34 of the intermediate sections 14 and the medial axis of the handles 16 facilitates the placement of equal force by the tool even if the coupler components are corroded.

Variations of the construction may be effected without departing from the spirit and scope of the invention. For example, the various prongs may have a distinct width or outer side configuration. Thus the invention is to be limited only by the following claims and equivalence thereof.

What is claimed is:

1. A tool for engaging and disconnecting air conditioning and fuel line couplers comprising:
(a) a first unitary element including a handle section joined to an intermediate pivot connection section joined, in turn, to a jaw section, said jaw section including a distal outer end, said first element intermediate section comprised of a plate formed to include a generally flat side, a pivot opening through the intermediate section, said pivot opening transverse to the flat side, said jaw section comprising generally flat coplanar first and second spaced prongs forming a coupler receiving slot, said slot having a generally uniform width and a slot centerline axis between said prongs, said slot open at the distal, outer end of the jaw section, said prongs and slot lying in a common plane of said jaw section, said common plane transverse to the first and second flat sides of the intermediate pivot section and said handle section, said centerline axis of said slot generally coincident with one of said flat planar sides of said intermediate connection pivot section and also coincident with a medial, longitudinal axis of said handle section intermediate the first and second sides;
(b) a second unitary element substantially identical to the first unitary element; and
(c) a pin fastener in said pivot openings of said intermediate sections pivotally connecting said first and second unitary elements with said intermediate section first sides in opposed abutting relationship, said jaw sections in opposed relation and said handles in opposed relation whereby said prongs may be engaged with a coupler in opposed substantially axially aligned relation when said prong slots are positioned on a said coupler.

2. The tool of claim 1 wherein the first and second elements are each fabricated in substantially identical form of precut flat stock having said substantially uniform thickness.

3. The tool of claim 1 wherein the lateral spacing of the prongs of the first jaw is greater than the lateral spacing of the prongs of the second jaw.

4. The tool of claim 1 wherein at least one of the prongs has a different width than the other prongs.

5. The tool of claim 1 wherein the centerline axis is generally coincident with the first flat side of the intermediate section.

6. The tool of claim 1 wherein the centerline axis is generally coincident with the second flat side of the intermediate section.

7. A tool for engaging and disconnecting air conditioning and fuel line couplers comprising:
(a) a first unitary element including a handle section joined to an intermediate pivot connection section joined, in turn, to a jaw section, said jaw section including a distal outer end, said first element intermediate section comprised of a plate formed to include a generally flat side, a pivot opening through the intermediate section, said pivot opening transverse to the flat side, said jaw section comprising generally flat coplanar first and second spaced prongs forming a coupler receiving slot, said slot having a generally uniform width and a slot centerline axis between said prongs, said slot open at the distal outer end of the jaw section, said prongs and slot lying in a common plane of said jaw section, said common plane transverse to the first and second flat sides of the intermediate pivot section and said handle section, said centerline axis of said slot generally coincident with one of said flat planar sides of said intermediate connection pivot section and also coincident with a medial, longitudinal axis of said handle section intermediate the first and second sides;
(b) a second unitary element substantially identical to the first unitary element; and
(c) a pin fastener in said pivot openings of said intermediate sections pivotally connecting said first and second unitary elements with said intermediate section first sides in opposed butting relationship, said jaw sections in opposed relation and said handles in opposed relation whereby said prongs may be engaged in opposed substantially axially aligned relation when said prong slots are positioned on a coupler.

8. The tool of claim 7 wherein the lateral spacing of the prongs of the first jaw is greater than the lateral spacing of the prongs of the second jaw.
